(19) United States
(12) Patent Application Publication
(10) Pub. No.: US 2004/0191515 A1
(43) Pub. Date: Sep. 30, 2004

(54) Pipe coating

(76) Inventor: Douglas Thomas Mullen, East Lothian (GB)

Correspondence Address: JACOBSON HOLMAN PLLC, 400 SEVENTH STREET N.W., SUITE 600, WASHINGTON, DC, 20004, US

(21) Appl. No.: 10/472,770

(22) PCT Filed: Apr. 9, 2002
(86) PCT No.: PCT/GB02/01535

(30) Foreign Application Priority Data
Apr. 9, 2001 (GB) 0108784.0

(51) Int. Cl. B05D 1/36

(52) U.S. Cl. 428/404; 427/402; 428/515

(57) ABSTRACT

A coating (4) for a pipe (1) adapted for use in the transportation of hydrocarbons between production and processing facilities, said coating comprising either a polypropylene or polyethylene copolymer mixed with sintered material of either polylpropylene or polyethylene.

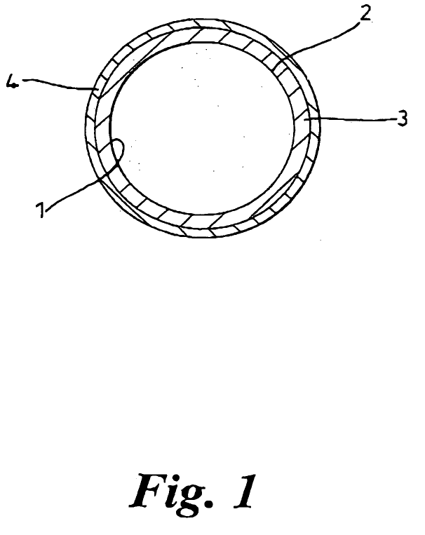

This invention relates to an improved pipe coating which is particularly but not exclusively suitable for use as a pipe coating for subsea pipe lines for transporting hydrocarbons from off shore production facilities to on shore processing facilities The invention also relates to a method of applying such a coating to a pipe and also a pipe when so coated.

Pipes which are adapted for the transportation of hydrocarbons between production and processing facilities must be able to operate in harsh and extreme conditions and are generally coated with a multi-layer coating to enable the pipes to operate effectively. For example, coatings may provide a protective shroud around the pipeline to prevent damage from occurring due to impact with objects or, may provide a weight coating to retain the pipeline on the sea bed. Insulating coatings may also be provided to enable the pipeline to transport certain production fluids. Suitable coating materials may include polypropylene, polyethylene and concrete.

In many cases, a layer of fusion bonded epoxy resin is applied to the outer surface of the pipe prior co the application of the outer protective coating. This enhances the bonding of the outer coating to the pipe. Fusion bonded epoxy is a chin film which has excellent corrosion protection properties but, when used in conjunction with heavy density marine concrete weight coating suffers from impingement damaged due to high speed particles penetrating the thin film coating which detracts from the coating's anti-corrosion properties.

Furthermore, the surface finish on such epoxy coating leaves little or no sheer resistance between itself and the applied concrete. This has caused difficulty when the pipes are being laid under dynamic tension on semi-submergible lay barges.

Several solutions to this problem have been sought to attempt to provide a barrier coating with an enhanced sheer resistance between the concrete outer coating and the fusion bonded epoxy interface. These have however, proved to be expensive or require a separate application thereby increasing the overall costs of the coating operation. Furthermore, such coatings do not-protect the entire epoxy surface and the addition of adhesives can cause difficulty due to the hydroscopic nature of the applied coating destroying the adhesive content by sucking it into the concrete as part of the-hydration process.

The present invention aims to provide a coating which overcomes or at least mitigates the above disadvantages and also enhances the performance properties of the fusion bonded epoxy coating itself giving improved impact resistance and improved sheer resistance.

According to one aspect of the present invention there is provided a coating for a pipe adapted for use in the transportation of hydrocarbons between production and processing facilities, said coating comprising either a polypropylene or polyethylene copolymer mixed with sintered material of either polypropylene or polyethylene.

Advantageously the coating has a thickness of around 75 microns.

Preferably, the sintered material is cryogenically ground.

According to a second aspect of the present invention there is provided a method of coating a pipe adapted for use in the transportation of hydrocarbons between production and processing facilities comprising the steps of applying a layer of fusion bonded epoxy over the outer surface of the pipe and applying a coating comprised of a layer of polypropylene or polyethylene copolymer mixed with a polypropylene or polyethylene sintered material over the fusion bonded epoxy.

Preferably, the copolymer and sintered material is applied over the fusion bonded epoxy while the epoxy is in the wet phase. This encourages cross bonding between the fusion-bonded epoxy and the copolymer layer to enhance the bond between the two layers.

Preferably also, a further layer of marine concrete is applied over the copolymer layer.

Advantageously, the epoxy layer is applied to a 350-500 micron thickness.

Conveniently, the copolymer layer is applied over the fusion bonded epoxy in a spraying application.

According to a still further aspect of the present invention there is provided a pipe provided with a coating comprising a layer of fusion bonded epoxy and a layer of polypropylene or polyethylene copolymer mixed with a sintered material of polypropylene or polyethylene.

Embodiments of the present invention will now be described with reference to and as shown in the accompanying Figure which shows a cross sectional view of a pipe coated with a coating according to one aspect of the present invention.

The pipe 1 is adapted for use in the transportation of hydrocarbons between production and processing facilities and is particularly suitable for subsea use between such facilities. A layer of fusion bonded epoxy 3 is applied over the outer surface 2 of the pipe. The fusion bonded epoxy may be sprayed onto the surface of the pipe to a thickness of around 350-500 microns and is applied at a temperature-of around 230° C. and cooled immediately after application.

A further coating 4 is provided over the fusion bonded epoxy, said further coating comprising a polypropylene or polyethylene copolymer which is mixed with either a polypropylene or polyethylene sinter to provide a rough surface coating The sintered coating may be sprayed onto the epoxy coating to form a layer of around 75 microns.

The sintered coating is preferably applied to the fusion bonded-epoxy while the epoxy is still in the wet stage of gel to promote cross bonding between the fusion bonded epoxy layer and the sintered coating. The sintered coating is applied cold onto the fusion bonded epoxy and bonds with the first layer through the latent heat of the fusion bonded epoxy without the requirement for further energy input.

The provision of the sintered coating over the fusion bonded epoxy provides impact resistance to the coated pipe and this enables the pipe coated with fusion bonded epoxy and the sintered coating to be transported with a reduced risk of damage occurring. This is advantageous as a protective coating of concrete is not required to protect the pipe and this obviously reduces the weight of the pipes in transit. Furthermore, the sintered coating promotes a vapour transfer barrier and prevents water ingress into the fusion bonded epoxy layer.

Additionally the sintered coating is applied cold onto the fusion bonded epoxy and uses the latent heat of the fusion bonded epoxy to bond with the epoxy. This enables the sintered coating to be applied in a cost effective and energy efficient manner.

The application of the sintered coating allows the thickness of the fusion bonded epoxy layer to be reduced whilst still retaining its flexibility characteristics. Furthermore, the sintered coating protects the fusion bonded epoxy from adverse temperature conditions and allows the pipes to carry a product which is at a higher temperature than a pipe coated only with fusion bonded epoxy. Additionally, the sintered coating provides a good base for the application of further protective coatings such as marine concrete and reduces slippage between the epoxy layer and such further coatings.

1. A coating for a pipe adapted for use in the transportation of hydrocarbons between production and processing facilities, said coating comprising either a polypropylene or polyethylene copolymer mixed with sintered material of either polypropylene or polyethylene.

2. A coating according to claim 1, wherein the coating has a thickness of around 75 microns.

3. A coating according to claim 1, wherein the sintered material is cryogenically ground.

4. (canceled)

5. A method of coating a pipe adapted for use in the transportation of hydrocarbons between production and processing facilities comprising the steps of applying a layer of fusion bonded epoxy over the outer surface of the pipe and applying a coating comprised of a layer of polypropylene or polyethylene copolymer mixed with a polypropylene or polyethylene sintered material over the fusion bonded epoxy.

6. A method according to claim 5, wherein the copolymer and sintered material is applied over the fusion bonded epoxy while the epoxy is in the wet phase.

7. A method according to claim 5, wherein a further layer of marine concrete is applied over the copolymer layer.

8. A method according to claim 6, wherein the copolymer layer is applied over the fusion bonded epoxy in a spraying application.

9. A method according to claim 5, wherein the epoxy layer is applied to a 350-500 micron thickness.

10. (canceled)

11. A pipe provided with a coating comprising a layer of fusion bonded epoxy and a layer of polypropylene or polyethylene copolymer mixed with a sintered material of polypropylene or polyethylene.

12. (canceled)
